(19) United States
(12) Patent Application Publication
(10) Pub. No.: US 2013/0179179 A1
(43) Pub. Date: Jul. 11, 2013

(54) Virtual Medicine Cabinet

(71) Applicant: Gyanendra Patra, Katy, TX (US)

(72) Inventor: Gyanendra Patra, Katy, TX (US)

(21) Appl. No.: 13/345,744

(22) Filed: Jan. 8, 2012

(51) Int. Cl. G06Q 50/22

(52) U.S. Cl. 705/2

(57) ABSTRACT

A method for consumer to receive e-prescription, shop and route to the pharmacy of choice based on price and availability comprises providing a Patient Portal within e-prescription software for prescribers to select such that the e-prescription can be transmitted to a system where the consumer is able to select the pharmacy based on price and availability. The system further comprises providing consumers inside their account the drug price and pharmacy information based on the price offered by the participating pharmacies, consumer's medical insurance, and consumer's own preference as well as providing consumers options to choose the pharmacy.

### BACKGROUND OF THE INVENTION

1. Field of the Invention

The present invention relates to a system and method for use with e-prescription, and more particularly to a system, where a consumer will receive e-prescriptions from his/her prescriber through an external system, and shop and route or simply route to the pharmacy of his/her choice based on price and availability without interfering the prescriber.

2. Description of Related Art

It is known that prescription drug price has wide variance among retail pharmacies even within the same geographic location. The price can vary 20% to 100% in every geographic location. According to one report, searches on a state managed price finder show that prices for the same drugs can vary from pharmacy to pharmacy by as much as 500 percent. Adding to this complexity, mail order pharmacies are normally 30% cheaper than the retail pharmacies and mail order pharmacy is growing at a fast rate which leads to increasing price variation of prescription drug nationwide.

Most of the consumers are concerned about the cost of their prescription medications. The out-of-pocket expense for prescription drugs is increased due to increasing insurance cost, increasing co-payment, increasing deductibles, etc. As such, consumers are forced to better control the cost of prescription drug and are forced to shop around for the best price. Nevertheless, shopping for the best price can be difficult and time consuming. It is known that the retail/mail order pharmacies may have daily price change for the same drug, but daily drug pricing information is not easily accessible. Except a few pharmacies (e.g. Costco, and Drugstore.com), most pharmacies do not advertise or even display prescription drug prices. The price lists of prescription drugs managed on state government website are limited to most commonly used prescription drugs and do not reflect the daily price change.

Moreover, there are several problems with the existing e-prescription drug delivery system where Surescripts directly connects prescribers to pharmacies.

In the existing e-prescriptions drug delivery system, there is no means for the consumer to compare and look for the lowest price for the same drug before choosing the pharmacy so it is more or less a random choice of the consumer when they choose the pharmacy for the prescriber to select (input) in the e-prescription. Because the prescriber is responsible for inputting the pharmacy information in the e-prescription software, once selected, this cannot be changed without the consumer asking the prescriber to cancel the existing one and recreate a new one by choosing a different pharmacy of consumer's choice. Up to now, there is no system or method in the prior art that addresses these problems.

Accordingly, there is a need for a system and method that provides a platform to connect consumers and pharmacies before the pharmacy information is filled into the e-prescription software such that the consumers can help themselves in choosing a pharmacy based on their criteria including lowest prescription drug price, availability, proximity and other offers. Moreover, the system and method should provide means for consumers to choose different pharmacies without having the prescriber involved.

### SUMMARY OF THE INVENTION

An object of the present invention is to let consumer in control to choose the pharmacy.

Another object of the present invention is to provide consumers options to find the pharmacy that offers the lowest-price for their prescription drug before the pharmacy information is filled into the e-prescription software thus reducing their prescription drug costs.

Another object of the present invention is to present to consumers the drug price and pharmacy information based on the price offered by the participating pharmacies, consumer's medical insurance, and consumer's own preference and providing consumers options to choose which pharmacy to send their e-prescription to.

The present invention relates to a system and method for use with e-prescription, and more particularly to a system, where a consumer will receive e-prescriptions from his/her prescriber through an external system, and shop and route or simply route to the pharmacy of his/her choice based on price and availability without interfering the prescriber. The aforementioned external system may be stand alone ePrescribe Software and/or hosted ePrescribe software and/or ePrescribe software integrated with EMR (electronic medical record) and/or HER (Electronic Health Record) system.

A system and method according to the present invention provides a website or app in mobile device for consumer to log in. Once the consumer registers on the website the system and method creates a consumer account and provides access credentials for consumer to log in. The system will provide a “Patient Portal” option within external e-prescription software for prescribers to select when using the e-prescription software provided by an e-prescription software vendor. When a consumer visits a prescriber who can be any medical professionals that are qualified to write a prescription, the consumer can ask the prescriber to send the e-prescription to the “Patient Portal” instead of any pharmacy. By selecting “Patient Portal”, the “e-prescription packet” populated with all the details by the e-prescription software will be sent to and stored in the central system of the web server (of the present invention). The central system will then allocate the e-prescription to the respective consumer account and notify the consumer or consumer's representative to log in the account and view the new e-prescription.

The system searches the pharmacies based on the prices offered by the participating pharmacies, consumer's medical, insurance information, and consumer's own preference. Then, the system presents possible price options offered by participating pharmacies—both for pick up as well as home delivery and provide the consumer an option to choose a pharmacy from a pharmacy list. The system also provides the consumer an option to skip the presentation of the price information and go ahead to select the pharmacy without looking at the price.

One embodiment further comprises a feature called automatic pharmacy selection by the system (patient portal) after the system receives the prescription payload from the ePrescribe software systems. In this embodiment, consumer can set her preferences in her account in the patient portal based on collection of criteria like (proximity, lowest price, proximity and lowest price etc, mail order only, pick up only, selected list of pharmacies) only or any combination of these, payment option with details), consumer can preselect the pharmacy choice criteria and save in her account. Upon receiving the ePrescription packet, patient portal can take decision automatically and notify consumer accordingly.

Once the pharmacy is selected, the system updates the e-prescription with the pharmacy information and delivers the e-prescription back to the e-prescription provider or directly to the pharmacy through the network.

In one embodiment, after the e-prescription is transmitted back to the e-prescription provider, the e-prescription software provider can further transmit the e-prescription to an intermediary service (e.g. Surescripts). In turn, the intermediary service further sends the e-prescription to a pharmacy for filling. In another embodiment, after the system directly sends the e-prescription to the pharmacy of consumer's choice, the system will provide payment information to the pharmacy. The pharmacy then dispenses the medication to consumer and updates the web server's central system with dispense details. In one embodiment, the system will pay the pharmacy.

In another embodiment of the present system, the consumer can ask prescriber to send the e-prescription to a pharmacy and simultaneously send a copy to the central system of the web server of the present invention. In this embodiment, consumer can view the new e-prescription in their account but cannot select pharmacy inside his account. The prescription will follow the existing e-prescription drug delivery system and filled by the pharmacy that they chose in the prescriber's office.

The system and method of the present invention includes computers and/or mobile devices with internet access in the prescriber's office and pharmacies. The computer or mobile device in the prescriber's office should be installed with e-prescription software or have access to the e-prescription software provider's website. Consumer can use computer or mobile device to register and log in the account on the website of the present invention. The networking implemented to connect the prescriber, software provider, the present invention's website's server (central system), consumer, intermediary service (e.g. Surescripts), and pharmacies involved in the present invention are known to those with ordinary skill in the arts.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart illustrating an exemplary existing system and method showing that the consumer has no control over prescription drug price.

FIG. 2 is a flow chart showing a first embodiment of the present invention that provides consumers control over selection of pharmacy based on price and availability.

FIG. 3 is a flow chart showing a second embodiment of the present invention that provides consumers control over selection of pharmacy based on price and availability.

FIG. 4 is a flow chart showing a third embodiment of the present invention that provides consumers a copy of e-prescription in consumer's account.

FIG. 5 is a diagram showing computer hardware/mobile device and network connecting the consumers, prescribers, e-prescription software provider, website according to the present invention, intermediary service, and retail/mail order pharmacies involved in the first embodiment disclosed in FIG. 2.

FIG. 6 is a diagram showing computer hardware/mobile device and network connecting the consumers, prescribers, e-prescription software provider, website according to the present invention, intermediary service, and retail/mail order pharmacies involved in the second embodiment disclosed in FIG. 3.

### DESCRIPTION OF THE PREFERRED EMBODIMENT

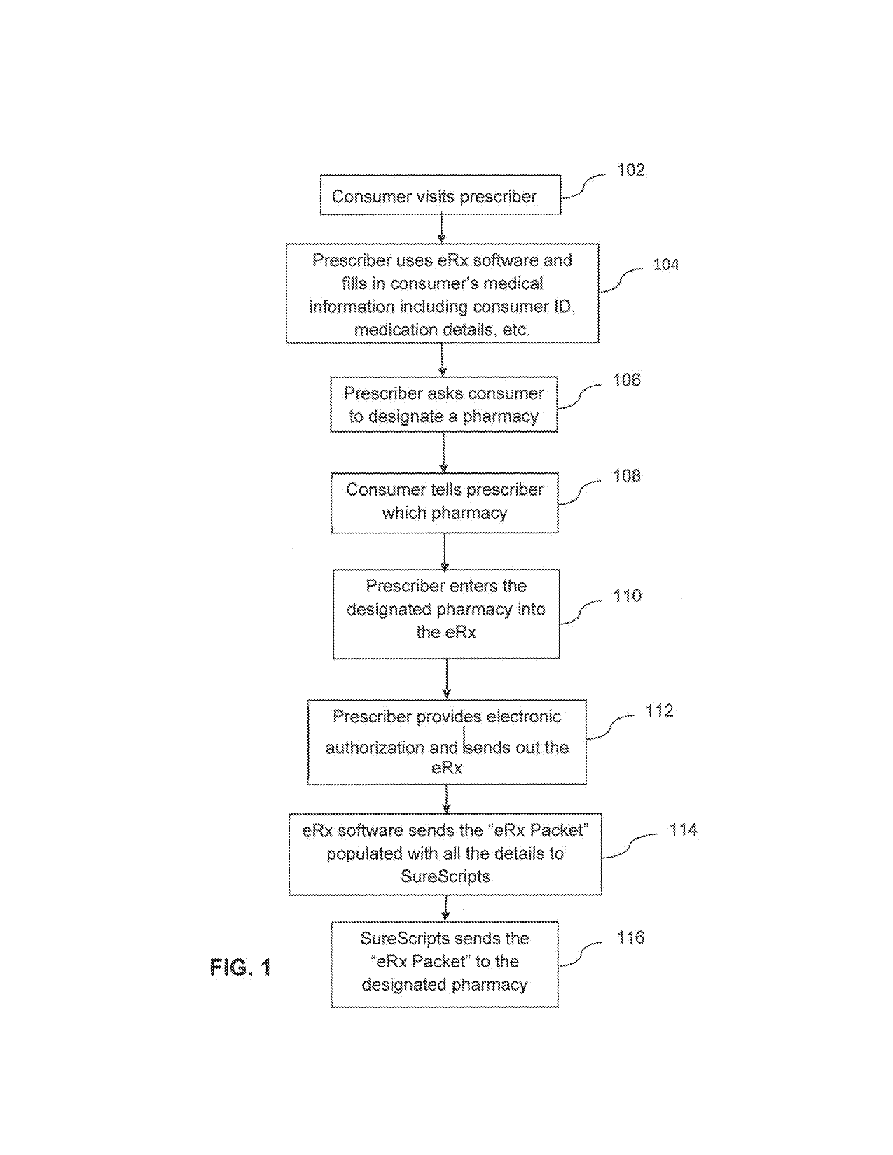

In order to grasp the advantage of the new system and method of the present invention over the existing system, before explaining the new system and method of the present invention, referring to FIG. 1 there is disclosed the work flow of the existing system and method. First, a consumer visits a prescriber (step 102). After examining the consumer, the prescriber decides to write a prescription using e-prescription software provided by an e-prescription software vendor. The prescriber enters prescriber's ID (pre-populated by the e-prescription software), consumer's ID (prescriber selects the consumer's ID if it is already there or adds the new consumer in the e-prescription software), and the medication details (step 104). Then, the prescriber asks consumer for the pharmacy and the consumer tells the prescriber his/her preferred pharmacy (step 106 and 108). The prescriber enters the pharmacy into the e-prescription, provides electronic authorization and sends the e-prescription to the e-prescription system provider (step 110 and 112). The e-prescription software in turn sends the “e-prescription packet” populated with all the details to Surescripts (step 114). In turn Surescripts sends this to the designated pharmacy to get it filled (step 116).

The existing system does not provide the consumer control over the prescription drug price or pharmacy because the pharmacy is a random choice of the consumer or doctor. Once selected, the pharmacy cannot be changed without the consumer asking the prescriber to cancel the existing one and recreate a new one by choosing a different pharmacy of consumer's choice. Even if the selected pharmacy is a well made decision at the time when consumer visited prescriber. Because the prescription drug price may change daily the selected pharmacy may not have the best deal all the time. The existing system and method does not provide tool to overcome a dynamic price changing market; the consumer is not given options to shop around for the best deal using the existing system.

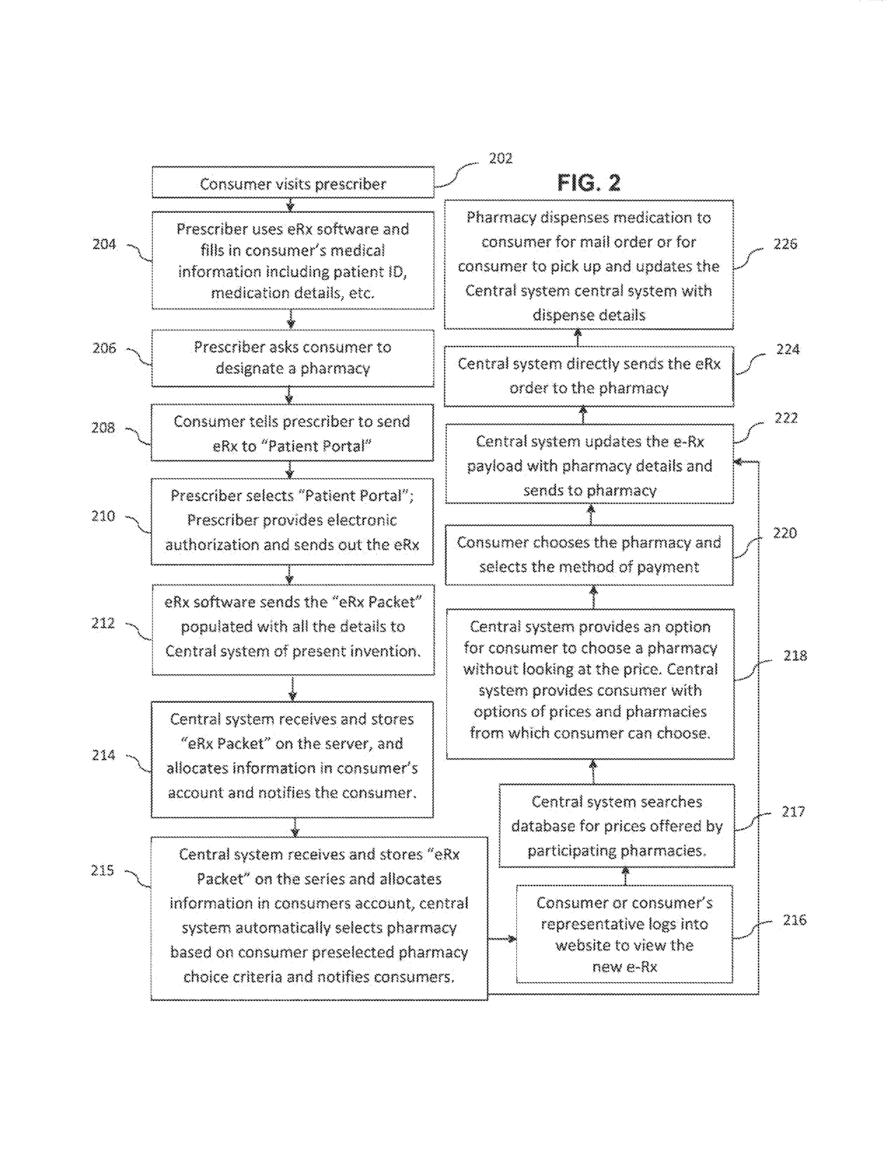

Referring to FIG. 2, there is disclosed a first embodiment of a new system and method according to the present invention. Steps 202 through 206 in FIG. 2 are the same as steps 102 through 106 in FIG. 1. Instead of randomly selecting a pharmacy, consumer asks prescriber to send the e-prescription to the “Patient Portal” in the e-prescription software which is the central system (step 208) of the present invention. Upon the consumer's request, the prescriber selects the “Patient Portal”, provides electronic authorization and sends out the e-prescription (step 210). Then, e-prescription software sending the “e-prescription packet” populated with all the details to the central system (step 212) of the present invention. After receiving the consumer's e-prescription packet, the present invention's central system stores e-prescription packet on the server and allocates information in consumer's account and notifies the consumer to take action (step 214). The consumer or consumer's representative logs into the present invention's central system either through website or the mobile device app that is provided by the present invention to view the new e-prescription (step 216). After looking up database offered by participating pharmacies and taking into consideration of consumer's insurance information, discounts, delivery cost as well as net price by combining multiple prescriptions if any (step 217), the present invention's central system presents possible price options offered by participating pharmacies—both for pick up as well as home delivery in the consumer's account. The present invention also provides an option for consumer to choose a pharmacy without looking at the price if the price is not consumer's concern (step 218). After reviewing all the information presented in the account, consumer chooses which retail pharmacy or mail order pharmacy he wants the prescription to be filled and the payment method (step 220). The present invention's central system captures the payment method and updates the e-prescription with the pharmacy information (step 222). Alternatively, upon receiving the e-prescription packet, the central system can automatically selects pharmacy based on consumer's preselected pharmacy choice criteria (e.g. proximity, lowest price, proximity and lowest price, mail order only, pick up only, selected list of pharmacies only, etc. and/or any combination thereof), as well as payment options saved in the account and notifies consumer accordingly (step 215). Then the present invention's central system directly sends the e-prescription and payment information to the pharmacy (step 224). Pharmacy dispenses medication to consumer and updates central systems with dispense details (step 226). Central system then may make payment to pharmacy. The order of steps may be altered in other embodiments.

According to this embodiment of the present system and method, the consumer is given options to make a sensible decision about the pharmacy and get the best deal based on the information that the present invention's system provides to them or their own collected information. The present invention deals with various participating retail and mail order pharmacies from which consumer can choose best deal.

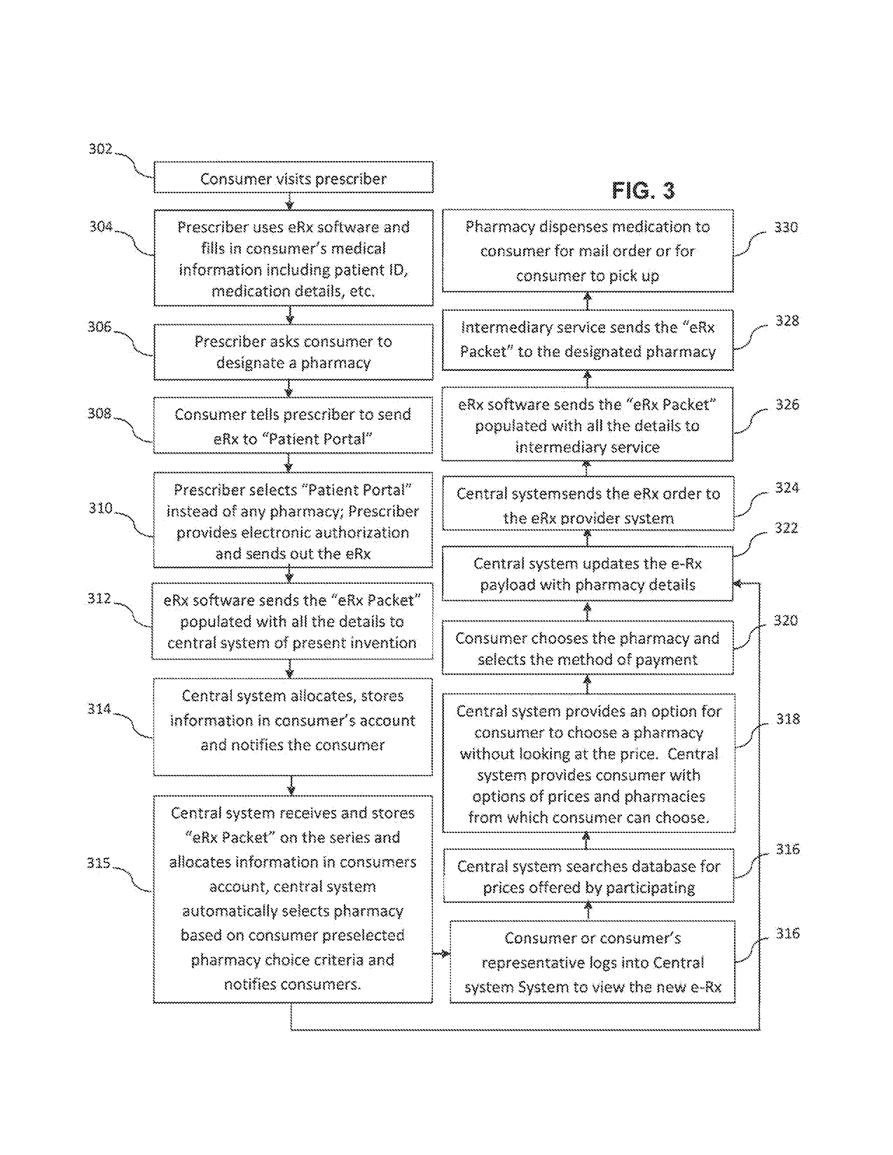

Alternatively, upon selecting the pharmacy, the present invention's central system will update the e-prescription with payload details and send it back to the e-prescription vendor's system electronically as illustrated in FIG. 3 (step 324). In this second embodiment, the e-prescription vendor will then continue sending the fully populated e-prescription payload to an intermediary service (e.g. Surescripts) (step 326). In turn the intermediary service sends this to the designated pharmacy (step 328). Pharmacy dispenses medication to consumer for mail order or for consumer to pick up (step 330). This embodiment also provides consumer control over selection of the pharmacy based on the information that the present invention's system provides to them or their own collected information. The order of steps may be altered in other embodiments.

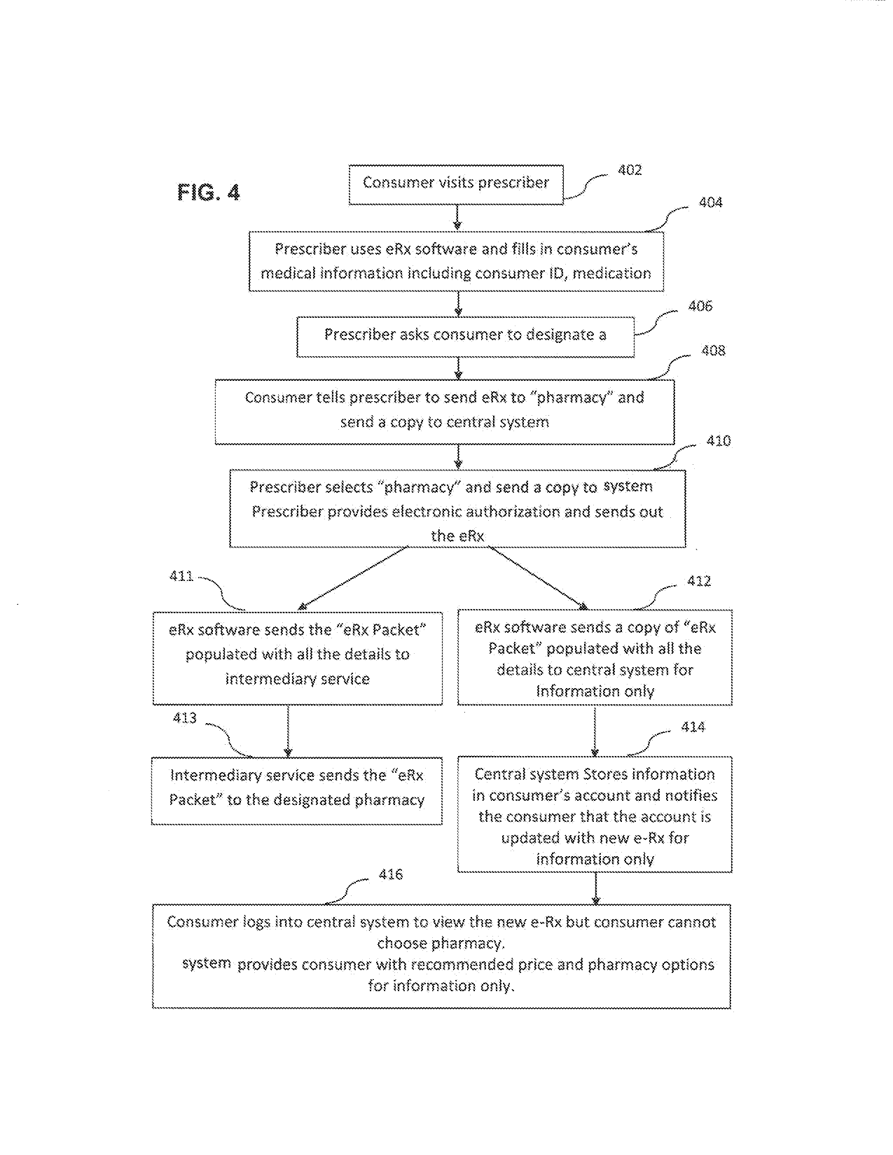

Referring to FIG. 4, there is disclosed a third embodiment of the present system where the consumer asks the prescriber to send the e-prescription to a pharmacy and sends a copy to the present invention's Patient Portal (step 410). By doing this, the e-prescription software sends the “e-prescription packet” populated with all the details to an intermediary service (e.g. Surescripts) (step 411). In turn, the intermediary service sends the “e-prescription packet” to the designated pharmacy (step 413). The present invention's central system receives the e-prescription for “Information Only” to be added to the consumer's online account for records (step 412 and 414). The consumer or consumer's representative can log in either through the present invention's website or using the mobile device app provided by the present invention and view the e-prescription and recommended options for the pharmacy and price but the consumer cannot change pharmacy inside the account (step 416). The order of steps may be altered in other embodiments.

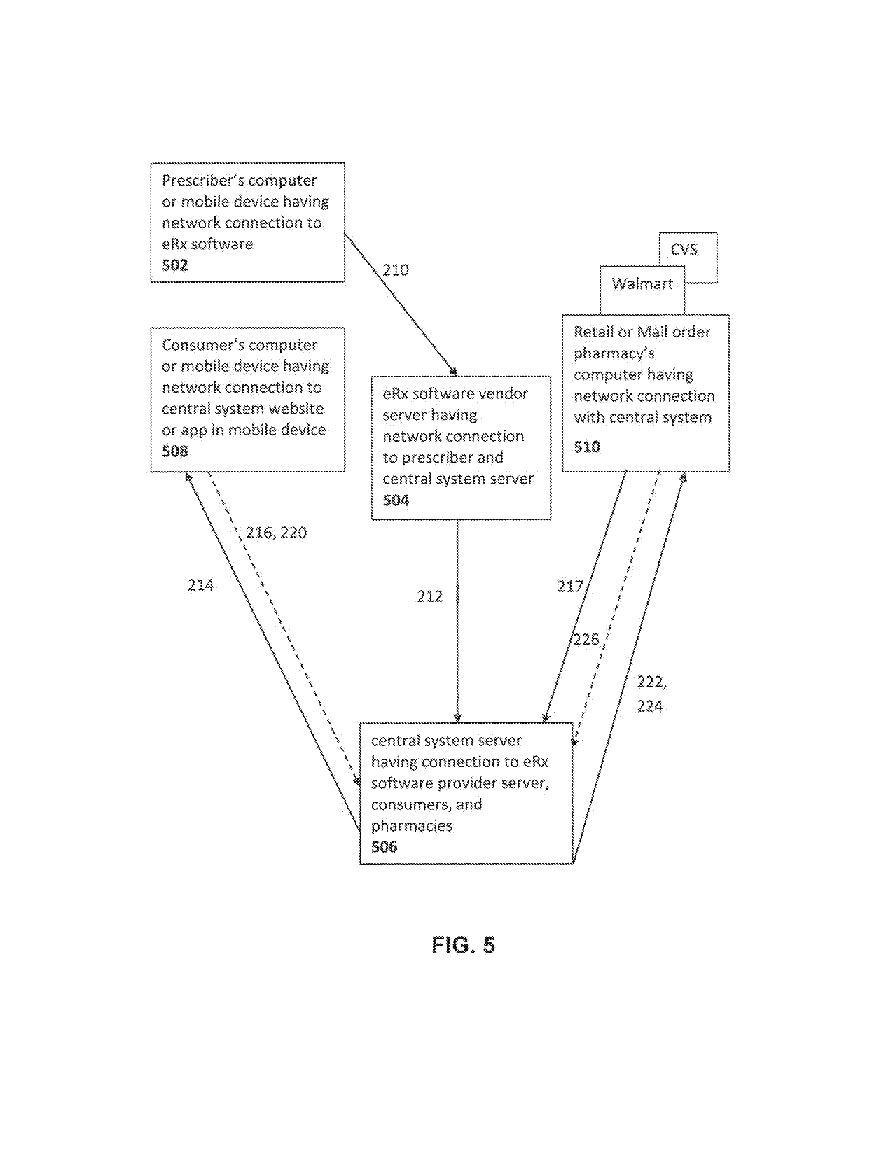

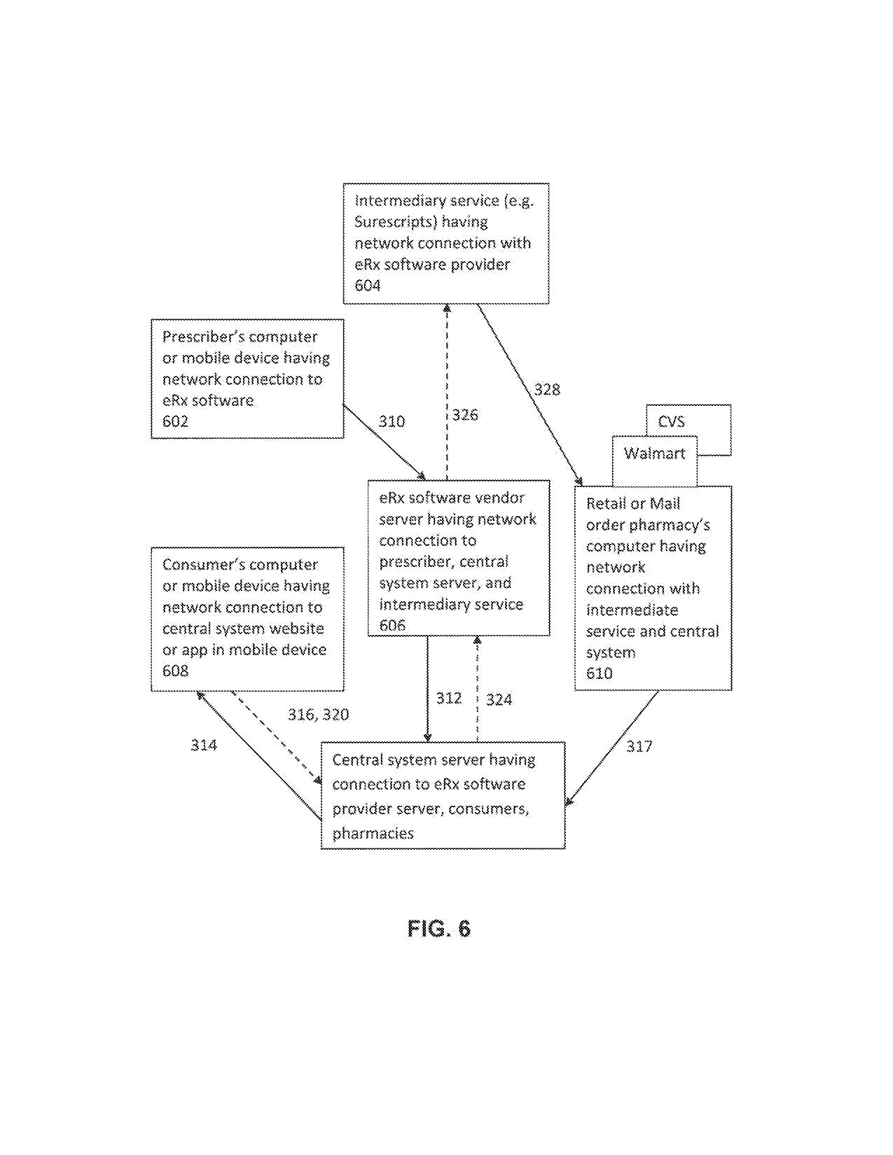

The system and method of the present invention includes computers and/or mobile devices with internet access in the prescriber's office and pharmacies. The computer or mobile device in the prescriber's office should be installed with e-prescription software or have access to the e-prescription software provider's website. Consumer can use computer or mobile device to register and log in the account on the present invention's website. The networking implemented to connect the prescriber, e-prescription software provider, present invention's website's server, consumer, intermediary service (e.g. Surescripts), and pharmacies are illustrated in FIG. 5 and FIG. 6. The networking arrangement is known to those with ordinary skill in the arts.

The network communication implemented in the first embodiment disclosed in FIG. 2 is illustrated in FIG. 5, where the prescriber's computer or mobile device 502 having network connection to e-prescription software; the e-prescription software vendor server 504 having network connection to prescriber and the present invention's server; the present invention's server 506 having connection to e-prescription software provider server, consumer, and participating and/or non-participating pharmacies; the consumer's computer or mobile device 508 having network connection to the present invention's website or app in mobile device; and the retail/mail order pharmacies' computers 510 having network connection with the present invention.

Referring to FIG. 6, there is disclosed a diagram showing the network connecting the parties involved in the second embodiment disclosed in FIG. 4 where the prescriber's computer or mobile device 602 having network connection to e-prescription software; the e-prescription software vendor server 604 having network connection to prescriber, intermediary service, and the present invention's server; the present invention's server 606 having connection to e-prescription software provider server, consumer, and participating and/or non-participating pharmacies; the consumer's computer or mobile device 608 having network connection to the present invention's website or app in mobile device; and the retail/mail order pharmacies' computers 610 having network connection with the present invention and intermediary service.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method comprising:
a. providing a website for consumers to log in;
b. creating consumer accounts on the website upon a consumers' registration and providing the consumers access credentials for logging in the accounts;
c. providing a “Patient Portal” option within an e-prescription software for prescribers to select when using the e-prescription software provided by an e-prescription software vendor;
d. receiving “e-prescription packet” populated with all the details by the e-prescription software and storing the “e-prescription packet” on the web server;
e. allocating the e-prescription to the respective consumer account and notifying the consumer or consumer's representative to log in the account and view the new e-prescription;
f. searching for the retail and mail order pharmacies that offers low prices of the prescribed medicines;
g. presenting possible price options offered by participating pharmacies;
h. providing the consumer option to choose pharmacy;
i. updating the e-prescription with the pharmacy information; and
j. delivering the e-prescription to a receiver through a network.

2. The method of claim 1 comprising:
a. providing app in mobile device for consumers to log in.

3. The method of claim 1, wherein the receiver being the e-prescription vendor so that the e-prescription can be further transmitted to the pharmacy of consumer's choice for filling of the prescription through the intermediary service.

4. The method of claim 1, wherein the receiver being a pharmacy of consumer's choice for filling of the prescription.

5. The method of claim 1 further comprising providing the consumer option to choose payment method; receiving the payment method; and delivering payment information to the pharmacy.

6. The method of claim 5 further comprising making payment to pharmacy after the pharmacy dispenses medication to consumer and updates the central system with dispense details.

7. The method of claim 1, wherein the method presenting possible price options offered by participating pharmacies after taking into consideration of consumer's pharmacy preference, insurance information, discounts, delivery cost as well as net price by combining multiple prescriptions if any.

8. The method of claim 1 further comprising providing consumer an option to skip the presentation of price information and go ahead to select the pharmacy without looking at the price.

9. The method of claim 1 further comprising establishing network communication between the website's server and the e-prescription software vendor in order for e-prescription software vendor to transmit the e-prescription to the website's server through a Patient Portal on e-prescription software.

10. The method of claim 1 further comprising establishing network communication between the website's server and retail/mail order pharmacies whereby the pharmacies offer drug price information to the website's server and get the e-prescription from the website's server.

11. The method of claim 1 wherein the e-prescription and consumer information provided in “e-prescription packet”, and price information provided by the participating retail/mail order pharmacies are stored in the database of the website's server.

12. The method of claim 1 further comprising automatic pharmacy selection after the system receives the prescription packet from the e-prescription software systems, the automatic pharmacy selection is based on the consumer's preselected pharmacy choice criteria.

13. A system comprising:
a. a website for consumers to register, log in and view e-prescription and various prices of a prescription drug from participating retail/mail order pharmacies and select the pharmacy of choice, the website creating consumer account upon consumers' registration;
b. a network setup that receives “e-prescription packet” including e-prescription and patient information from e-prescription software providers;
c. a network setup that receives various prices of a prescription drug from participating retail/mail order pharmacies; and
d. a database on the website's server to store e-prescription and consumer information, and the various prices of a prescription drug from different retail/mail order pharmacies.

14. The system of claim 13 further comprising:
a network setup that sends e-prescription to the pharmacy of consumer's choice for filling of the prescription after the consumer makes selection on the website.

15. The system of claim 13 further comprising:
a network setup that sends e-prescription to the e-prescription vendor so that the e-prescription can be further transmitted to the retail or mail order pharmacy of consumer's choice for filling of the prescription through the intermediary service after the consumer makes selection on the website.

16. The system of claim 13, wherein the “e-prescription packet” is sent through network after the prescriber select “Patient Portal” within the e-prescription software.

17. A method comprising:
providing a “Patient Portal” within e-prescription software for prescribers to select such that the e-prescription can be transmitted to a system where the consumer is able to select the pharmacy based on price and availability.

18. The method of claim 17 further comprising providing consumers inside their account the drug price and pharmacy information based on the price offered by the participating pharmacies, consumer's medical insurance, and consumer's own preference and providing consumers options to choose the pharmacy.

19. The method of claim 18 further comprising updating the e-prescription with the pharmacy information and sending the e-prescription to the pharmacy selected by the consumer for prescription filling.

20. The method of claim 18 further comprising updating the e-prescription with the pharmacy information and sending the e-prescription back to the e-prescription server which in turn transmits the e-prescription to an intermediary service which in turn sends the e-prescription to the pharmacy selected by the consumer for prescription filling.
